(19) United States
(12) Patent Application Publication
(10) Pub. No.: US 2026/0177159 A1
(43) Pub. Date: Jun. 25, 2026

(54) EXTERIOR SURFACE FLUID RELIEF APPARATUSES, AND ASSOCIATED SYSTEMS AND METHODS

(71) Applicant: SENSEI AG HOLDINGS, INC., Santa Monica, CA (US)

(72) Inventor: William Daniel Hillis, Santa Monica, CA (US)

(21) Appl. No.: 18/990,245

(22) Filed: Dec. 20, 2024

(51) Int. Cl. F16K 17/04; A01G 9/14; E04D 13/04

(52) U.S. Cl. CPC F16K 17/0413; A01G 9/1407; E04D 2013/0427

(57) ABSTRACT

Exterior surface fluid relief apparatuses and associated systems and methods are disclosed. The disclosed technology provides a fluid relief system comprising a drain apparatus coupled to a flexible membrane, where the drain apparatus is configured to drain fluid through an opening of the flexible membrane based on meeting or exceeding a threshold weight of the fluid on the flexible membrane. The flexible membrane is coupled to an exterior surface of a structure, such as a greenhouse. The drain apparatus is coupled to the flexible membrane such that the drain apparatus covers the opening. The system is also comprised of a channel structure configured to receive fluid passing through the opening of the flexible membrane, and to transport the fluid away from the flexible membrane.

### TECHNICAL FIELD

Various of the disclosed embodiments concern fluid relief apparatuses and associated systems and methods.

### BACKGROUND

Many plants are grown indoors where a desired growth environment can be maintained and controlled. For example, many plants in the agricultural industry are grown inside greenhouses, which are configured to maintain and control temperature, humidity, light exposure, and many other conditions to guide and/or optimize the growth rate, morphology, fruit/flower production, and many other characteristics of the greenhouse plants.

To increase and/or control light exposure, many greenhouses include roofs or sections of roofs comprised of transparent and/or semitransparent materials, such as glass, fiberglass, acrylic, polycarbonate, and/or polyethylene. These roofing materials are configured to permit natural light to penetrate the roof in order to reach the plants inside the greenhouse. However, challenges arise when using some transparent and/or semitransparent materials. For example, some polymer films may deform and/or rupture when excessive water (e.g., rainwater) accumulates on the film. Deformation may weaken the structural integrity of the film, and may result in a reduced ability to allow natural light into the greenhouse. Moreover, film rupture can result in plant damage and expensive repair costs.

### BRIEF DESCRIPTION OF THE DRAWINGS

One or more embodiments of the present disclosure are illustrated by way of example and not limitation in the figures of the accompanying drawings, in which like references indicate similar elements.

FIGS. 1A and 1B are cross-sectional views of a system, configured in accordance with some embodiments of the disclosed technology.

FIGS. 2A–2C are schematic illustrations of a system, configured in accordance with some embodiments of the disclosed technology.

FIG. 3 is a cross-sectional view of a drain apparatus, configured in accordance with some embodiments of the disclosed technology.

FIG. 4 is a cross-sectional view of a drain apparatus, configured in accordance with some embodiments of the disclosed technology.

FIG. 5A is a partially perspective view of a drain apparatus, configured in accordance with some embodiments of the disclosed technology.

FIG. 5B is a partially-schematic cross-sectional view of the drain apparatus of FIG. 5A.

FIG. 6 is a flow diagram of a method, in accordance with some embodiments of the disclosed technology.

### DETAILED DESCRIPTION

Exterior surface fluid relief apparatuses and associated systems and methods are disclosed. In many environmentally-controlled structures configured to optimize and guide the growth of plants (e.g., greenhouses), the exterior surfaces (e.g., roofs) are configured to admit external light (e.g., natural light) to the plants inside the structures. For example, some greenhouse roofs use a polymer film or other transparent material attached (e.g., via one or more clamping devices) at the edges of an opening in the roof. To prevent pooling/accumulation of fluid (e.g., rainwater), on the polymer film, the film is generally configured to be flexible enough to bulge outward in a convex shape when a positive pressure is applied to the interior of the greenhouse, thus allowing fluid to slide off of the film. However, in such systems, a loss of the positive pressure source (e.g., loss of power and/or mechanical failure of one or more electric fans) can result in a buildup of fluid on the film. This in turn can lead to the eventual deformation and/or rupture of the film.

The disclosed technology addresses this and other issues by providing a fluid (e.g., water) relief system comprising a drain apparatus coupled to a flexible membrane (e.g., a polymer film), where the drain apparatus is configured to drain fluid through an opening of the flexible membrane based on meeting or exceeding a threshold weight, amount, volume, and/or pressure of the fluid on the flexible membrane (for purposes of simplicity, “threshold weight” is used as a primary example throughout the application, but amount, volume, pressure, force, and the like can also be used). The flexible membrane is coupled to an exterior surface of a structure (e.g. a greenhouse roof). The drain apparatus is coupled to the flexible membrane such that the drain apparatus covers (e.g., forms a seal over) the opening.

In some embodiments, the system is also comprised of a channel structure, such as a hose and/or additional flexible membranes, configured to receive fluid passing through the opening of the flexible membrane and to transport the fluid away from the flexible membrane. Thus, one advantage of the disclosed drain apparatus and system is that fluid can be directed through and/or away from the flexible membrane before the weight of the fluid causes the flexible membrane to deform and/or rupture.

In some embodiments, the drain apparatus is configured to transmit gas (e.g., air) from inside the structure to outside the structure via the opening based on a pressure of an interior area of the structure. For example, the drain apparatus can be configured to relieve an overpressure or high-pressure condition inside a greenhouse and/or a low pressure condition outside the greenhouse by decoupling a portion of the drain apparatus (e.g., a plug portion) from the flexible membrane based on meeting or exceeding a threshold pressure within the greenhouse, meeting or exceeding a threshold differential pressure across the drain apparatus, and/or meeting or decreasing below a threshold pressure in an area outside the greenhouse that is proximate the drain apparatus.

In some embodiments, the drain apparatus is configured to allow light to transmit through the drain apparatus while one or more portions of the drain apparatus are coupled to the flexible membrane. Thus, one advantage of the disclosed drain apparatus and system is that the drain and/or pressure relief functions of the drain apparatus are enabled while still permitting sufficient light to pass through to the interior of the structure to, for example, facilitate plant growth.

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

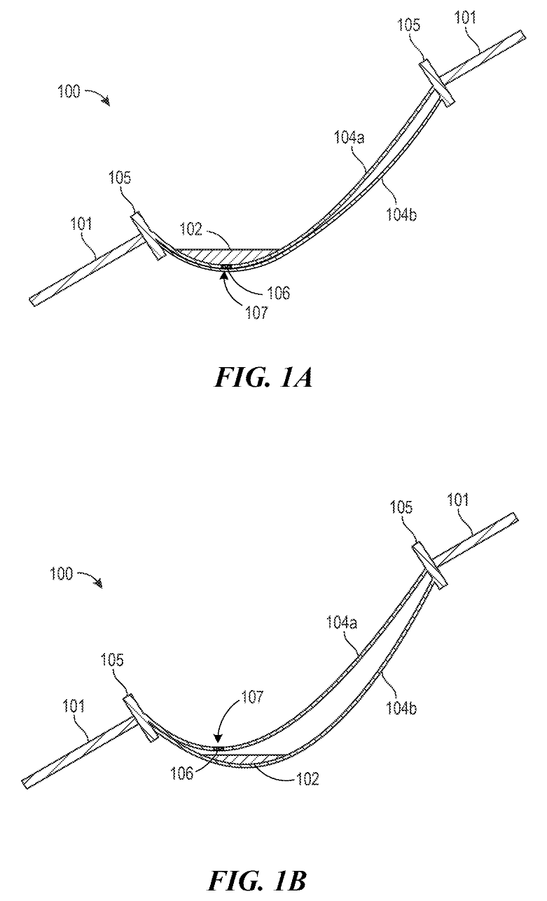

FIG. 1A is a cross-sectional view of a system 100, configured in accordance with some embodiments of the disclosed technology. In the present embodiments, system 100 is comprised of an exterior surface 101 of a structure with one or more flexible membranes (represented in FIGS. 1A and 1B as a first flexible membrane 104a and a second flexible membrane 104b) coupled to the exterior surface 101. For example, the first and second flexible membranes 104a and 104b can be clamped via clamping mechanism 105 to a section of a greenhouse roof. In some embodiments, the exterior surface 101 can be at least approximately flat (i.e., perpendicular to a direction of gravity). In some embodiments, the exterior surface 101 can be angled with respect to ground, such as an angled section of roof.

In some embodiments, the flexible membranes 104a, 104b, are configured to provide a weather-resistant boundary between the exterior and interior of the structure while also admitting outside light (e.g., natural sunlight) to the interior of the structure. In some embodiments, one or more of the flexible membranes 104a, 104b, are comprised of a transparent and/or semitransparent material, such as a polymer film. In some embodiments, one or more of the flexible membranes 104a, 104b, are comprised of a translucent material, such as polyethylene and/or ethylene tetrafluoroethylene (ETFE).

In some embodiments, the flexible membranes 104a, 104b, are configured to stretch and/or extend outward in a convex shape or “bubble” from the greenhouse in response to a positive pressure from the interior of the greenhouse. For example, one or more electric fans can provide a positive interior pressure in the greenhouse, relative to external and/or atmospheric pressure. In such embodiments, the convex shape of the flexible membranes 104a, 104b, can allow fluid (e.g., fluid 102), such as rainwater, to drain off of the flexible membranes 104a, 104b.

In some embodiments, fluid 102 can pool and/or accumulate on the one or more of the flexible membranes 104a, 104b. For example, if the positive pressure source in the greenhouse is not operating (e.g., loss of power to the electric fans, the fans are mechanically secured, etc.), the convex shape of the flexible membranes 104a, 104b, can collapse, allowing fluid 102 to pool on the first flexible membrane 104a (as shown in FIG. 1A). If the weight of the fluid 102 pooled on the flexible membranes 104a, 104b, meets or exceeds a threshold weight, the flexible membranes 104a, 104b can become deformed and/or rupture. In some embodiments, the fluid 102 will pool about a determined low point 106 of the first flexible membrane 104a.

In some embodiments, the low point 106 is the lowest point relative to ground of the first flexible membrane 104a when fluid 102 pools in the first flexible membrane 104a. In some embodiments, low point 106 is at least approximately in the center of the first flexible membrane 104a (e.g., if the flexible membrane 104a is positioned horizontal with respect to ground). In some embodiments, low point 106 is offset a distance from the center of the first flexible membrane 104a. For example, low point 106 can be offset based on the angle of the roof and/or external surface 101, the material composition of the first flexible membrane 104a, the actual or expected density and/or weight of the fluid 102, the tensile strength of the first flexible membrane 104a, the geometry of the first flexible membrane 104a with respect to the exterior surface 101 and/or to ground, weather conditions, and the like.

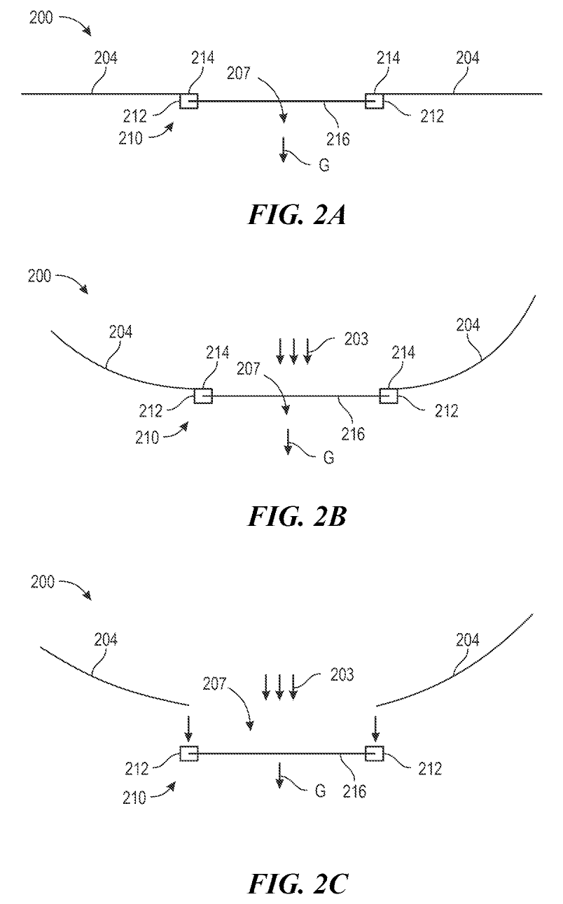

In some embodiments, one or more drain apparatuses (discussed further herein and with reference to FIGS. 2A–6) are coupled to the flexible membrane 104a and/or 104b. The drain apparatuses are configured to drain pooled/accumulated fluid 102 on the flexible membranes 104a, 104b through an opening 107 of the first flexible membrane 104a when a weight of the fluid 102 on the first flexible membrane 104a meets or exceeds a threshold weight. In some embodiments, the threshold weight corresponds to a deformation or rupture value of the first flexible membrane 104a. In some embodiments, the threshold weight can be determined, for example, based on the material properties of the flexible membranes 104a, 104b, and/or the properties of the fluid 102. In some embodiments, at least one of the drain apparatuses is positioned at least approximately at the determined low point 106. In some embodiments, the opening 107 of the first flexible membrane 104a is positioned at least approximately at the determined low point 106.

As shown in FIGS. 1A and 1B, in some embodiments, the second flexible membrane 104b can be configured to operate as a drain apparatus with regard to the first flexible membrane 104a. That is, the second flexible membrane 104b can be configured to drain pooled/accumulated fluid 102 on the first flexible membrane 104a through the opening 107 of the first flexible membrane 104a when a weight of the fluid 102 on the first flexible membrane 104a meets or exceeds a threshold weight.

For example, the second flexible membrane 104b can be coupled to the first flexible membrane 104a via an adhesive (e.g., glue, tape, etc.) such that the second flexible membrane 104b forms a water-proof and/or water-resistant barrier over the opening 107 (as shown in FIG. 1A). When a threshold weight of fluid 102 accumulates on the first flexible membrane 104a, the adhesive force between the first and second flexible membranes 104a, 104b can be overcome, causing the second flexible membrane 104b to decouple from the first flexible membrane 104a. This causes the opening 107 to become uncovered, allowing the fluid 102 to pass through the opening 107 and be received by the second flexible membrane 104b (as shown in FIG. 1B).

In some embodiments, at least one of the flexible membranes 104a, 104b, is configured to provide a channel structure (e.g., a trough, a funnel, and/or the like) that receives fluid 102 passing through the opening 107 of the first flexible membrane 104a, and transports the fluid 102 away from the flexible membranes 104a, 104b. For example, in some embodiments, the first flexible membrane 104a can have a drain apparatus (not shown) positioned at the low point 106, configured to drain pooled fluid 102 through an opening 107 of the first flexible membrane 104a. The second flexible membrane 104b is positioned below the first flexible membrane 104a, and is configured to receive fluid 102 that passes through the opening of the first flexible membrane 104a, and to transport the fluid 102 away from the first flexible membrane 104a (for example, to an end drain).

FIGS. 2A–2C are schematic illustrations of a system 200, configured in accordance with some embodiments of the disclosed technology. In some embodiments, system 100 includes components and features generally similar/identical to system 100 of FIGS. 1A and 1B. Accordingly, like reference numbers indicate like features and components.

Referring to FIG. 2A, system 200 includes a flexible membrane 204 with an opening 207. A drain apparatus 210 is coupled to the flexible membrane 204 via a coupling component 212. In some embodiments, the drain apparatus 210 is coupled to the flexible membrane 204 such that a water-proof or near-water-proof seal is formed across the opening 207. The coupling component 212 is configured to provide an interface, such as a surface, between the drain apparatus 210 and the flexible membrane 204 that includes an adhesive 214. For example, the coupling component 212 can be a disk, a square, or other shape that can support a surface and/or interface between flexible membrane 204 and the drain apparatus 210.

The adhesive 214 is configured to couple (e.g., bond) the flexible membrane 204 to the coupling component 212. For example, the adhesive 214 can be glue, epoxy, tape, and the like. As discussed further herein, in some embodiments, the adhesive 214 is configured to decouple the drain apparatus 210 from the flexible membrane 204 when a threshold weight of fluid 203 on the flexible membrane 204 is met or exceeded (e.g., the adhesive 214 bond between the flexible membrane 204 and the coupling component 212 is released when a threshold weight of fluid 203 is exceeded).

In some embodiments, the drain apparatus 210 includes a film section 216 extending between the edges of the coupling component 212. For example, where the coupling component 212 is a hollow disk, the film section 216 can extend across the hollow area in between the rim and/or interior perimeter of the disk portion of the drain apparatus 210. In some embodiments, the film section 216 is a transparent and/or semitransparent material configured to admit at least some light through the opening 207. In some embodiments, the film section 216 is comprised of the same material as the flexible membrane 204.

FIG. 2B shows a condition where the flexible membrane 204 is curving and/or stretching in a downward direction relative to a direction of gravity G. For example, where the flexible membrane 204 is coupled to the roof of a greenhouse, the curvature of the flexible membrane 204 downward can be due to a loss of a positive pressure source in the greenhouse, combined with a weight of fluid 203 accumulating on the flexible membrane 204.

FIG. 2C shows a condition where the drain apparatus 210 has decoupled from the flexible membrane 204. For example, where a threshold weight of fluid 203 has accumulated on the flexible membrane 204, the adhesive 214 coupling the coupling component 212 to the flexible membrane 204 can break and/or decouple, resulting in the drain apparatus 210 decoupling from the flexible membrane 204 and descending in a downward direction (e.g., in a direction of gravity G). In some embodiments, the adhesive 214 is configured to provide an adhesive force between the drain apparatus 210 and the flexible membrane 204 that is less than a force corresponding to deformation and/or rupture of the flexible membrane 204. In some embodiments, the threshold weight of fluid 203 is based at least in part on the force corresponding to deformation and/or rupture of the flexible membrane 204. In such embodiments, when the threshold weight of fluid 203 is met or exceeded, the decoupling of the drain apparatus 210 from the flexible membrane 204 allows the fluid 203 to drain through the opening 207 before the flexible membrane 204 is deformed and/or ruptured. Thus, the drain apparatus 210 mitigates and/or prevents deformation and/or rupture of the flexible membrane 204. In some embodiments, the fluid 203 passing through the opening 207 is received by a channel structure, such as one or more additional flexible membranes, troughs, hoses, and the like.

In some embodiments, the drain apparatus 210 is configured to transmit gas (e.g., air) from one side of the flexible membrane 204 (e.g., a side facing toward an interior area of a greenhouse) to the other side of the flexible membrane 204 (e.g., a side facing away from the interior area of the greenhouse). In such embodiments, the drain apparatus 210 is configured to decouple from the flexible membrane 204 based on a threshold pressure of a side (e.g., a surface) of the flexible membrane 204 and/or drain apparatus 210, an area proximate the flexible membrane 204 and/or drain apparatus 210, and/or a differential pressure across the flexible membrane 204 and/or drain apparatus 210. For example, when a threshold differential pressure is met or exceeded across the drain apparatus 210 (e.g., as a result of aerodynamic forces of wind creating a low pressure condition on an exterior surface of the flexible membrane 204 and/or on the drain apparatus 210), the drain apparatus 210 can decouple and/or pop out from the flexible membrane 204 to allow air to pass through the opening 207, thus relieving pressure across the drain apparatus 210 and/or flexible membrane 204. This can mitigate and/or prevent flexible membrane 204 rupture or deformation when such pressure conditions are present.

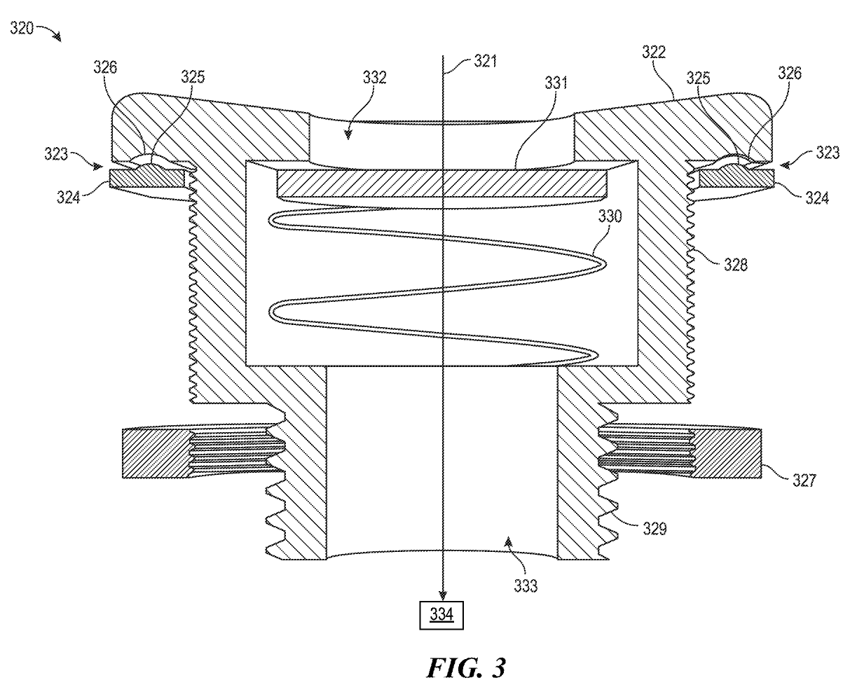

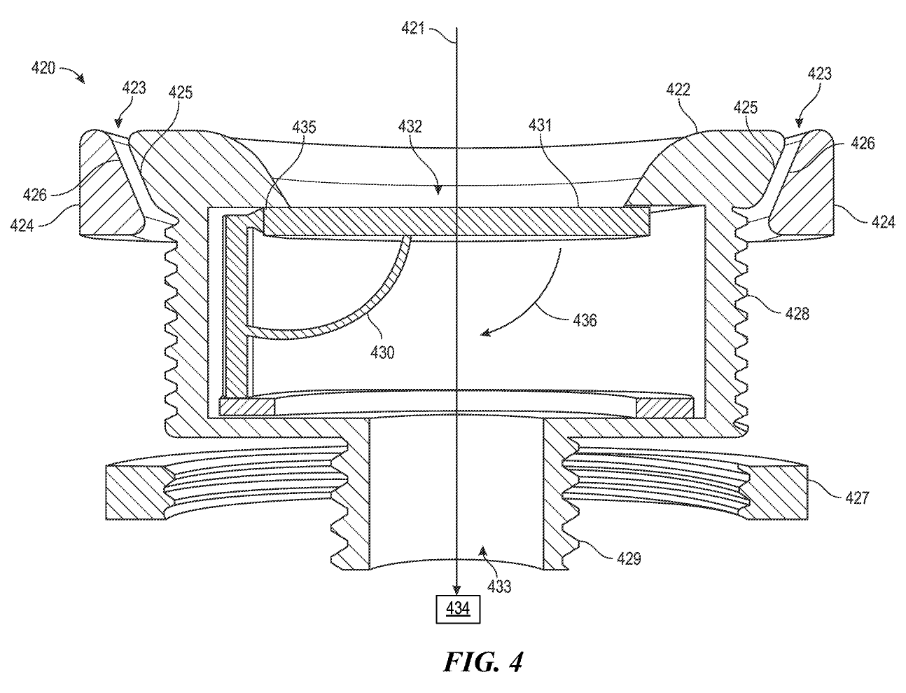

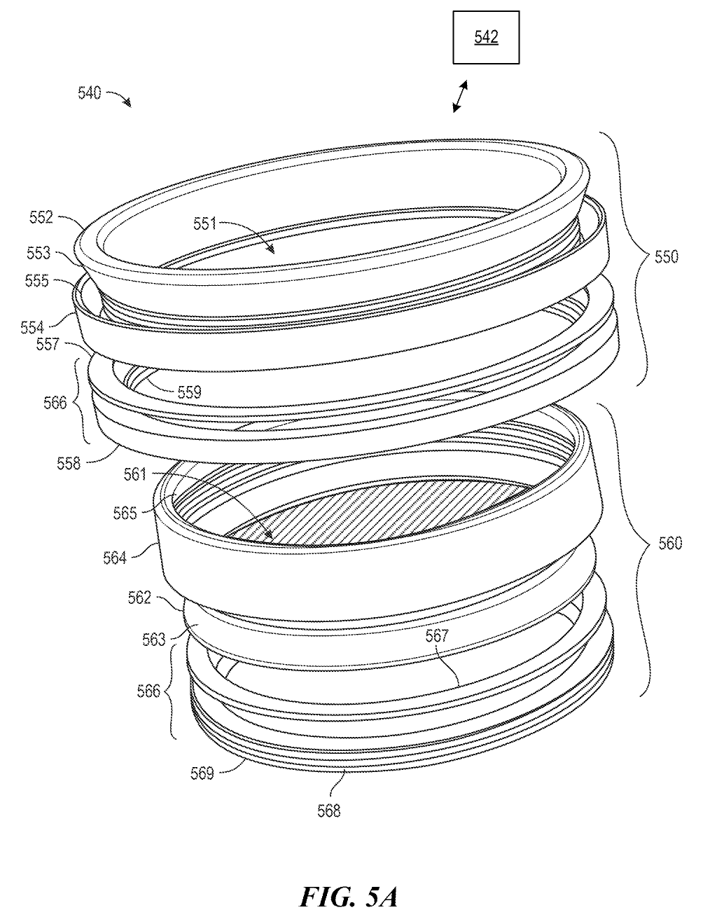

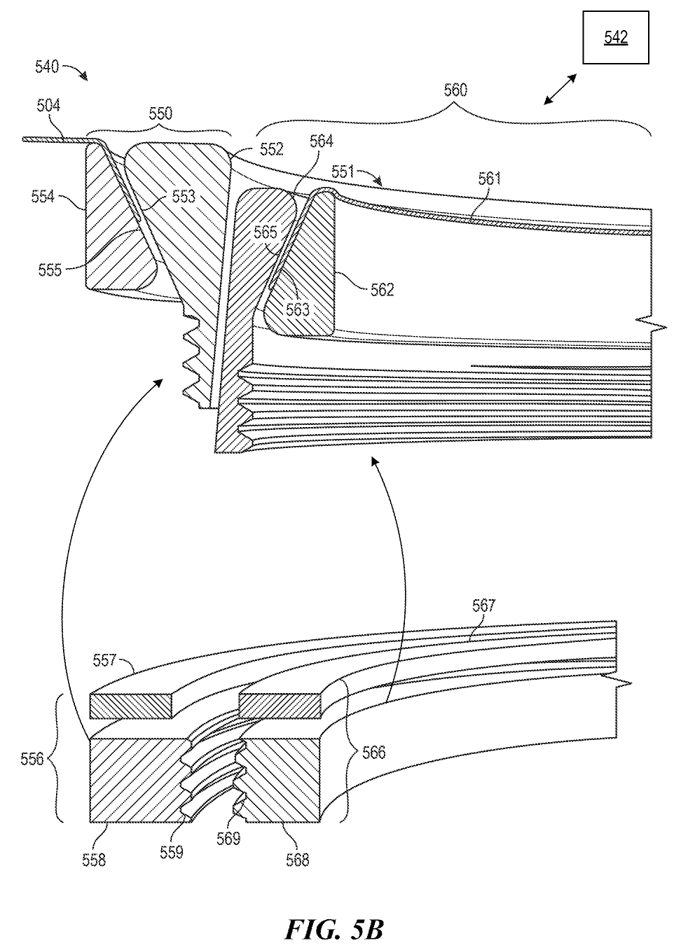

FIG. 3 is a cross-sectional view of a drain apparatus 320, configured in accordance with some embodiments of the disclosed technology. In some embodiments, drain apparatus 320 includes features and components generally similar/identical to features and components of any of the other embodiments of drain apparatuses discloses throughout this document (e.g., drain apparatus 210 of FIGS. 2A–2C, drain apparatus 420 of FIG. 4, and/or drain apparatus 540 of FIGS. 5A and 5B).

In the present embodiments, the drain apparatus 320 is configured to be coupled to a flexible membrane (not shown, e.g., the flexible membrane 204 of FIGS. 2A–2C) such that fluid can flow through an opening of the flexible membrane in response to meeting or exceeding a threshold weight of fluid, such as rainwater. The drain apparatus 320 is comprised of a housing 322 including an inlet 332 and an outlet 333, which define a flow path 321 through the interior of the housing 322. Within the housing 322 is a disk 331 (e.g., a valve disk) configured to be held against the inlet 332 via a force applied by a spring 330 coupled to the disk 331. In operation, when a threshold weight of fluid is present on the exterior surface of the disk 331 (e.g., a surface of the disk 331 opposite the spring 330), the spring force of the spring 330 is overcome, and the disk 331 is pushed away from the inlet 332, allowing the fluid on top of the disk 331 to flow via flow path 321 through the housing 322 and out the outlet 333. In some embodiments, the drain apparatus 320 is a relief valve, such as a spring-loaded pressure relief valve.

In some embodiments, a channel structure 334, such as a hose or a trough, is configured to receive the fluid discharging from the outlet 333 of the housing 322. In some embodiments, the channel structure is coupled (e.g., via fastener threads, clamps, etc.) to a lower section 329 of the housing, to ensure a contained and/or enclosed flow path 321 from inlet 332 to outlet 333 and away from the drain apparatus 320.

In some embodiments, the drain apparatus 320 is configured to couple to the flexible membrane via a sealing nut 327 and a sealing washer 324. The sealing nut 327 is configured to couple to an upper section 328 of the housing 322 (e.g., via fastener threads, clamps, etc.) such that the sealing nut 327 provides a mechanical force on the sealing washer 324 that clamps the sealing washer 324 to the housing 322. In some embodiments, a portion of the flexible membrane is positioned in clamping location 323, which is between the sealing washer 324 and a portion of the housing 322. When the sealing nut 327 applies the mechanical force to the sealing washer 324, the portion of the flexible membrane is clamped in clamping location 323 between the sealing washer 324 and the housing 322. In some embodiments, the housing 322 includes a notch 326 (e.g., groove, recess, etc.) configured to receive and/or mate with a corresponding projection 325 (e.g., bump, protrusion, raised portion, etc.) of the sealing washer 324. When the flexible membrane is positioned in location 323 and the sealing washer 324 is clamped to the housing 322, the notch 326 and projection 325 stretch the portion of the flexible membrane in location 323, providing a stronger coupling force between the drain apparatus 320 and the flexible membrane.

FIG. 4 is a cross-sectional view of a drain apparatus 420, configured in accordance with some embodiments of the disclosed technology. In some embodiments, drain apparatus 420 includes features and components generally similar/identical to features and components of any of the other embodiments of drain apparatuses discloses throughout this document (e.g., drain apparatus 210 of FIGS. 2A–2C, drain apparatus 320 of FIG. 3, and/or drain apparatus 540 of FIGS. 5A and 5B).

In the present embodiments, similar to drain apparatus 320 of FIG. 3, the drain apparatus 420 is configured to be coupled to a flexible membrane such that fluid can flow thrown an opening of the flexible membrane in response to meeting or exceeding a threshold weight of fluid. The drain apparatus 420 is comprised of a housing 422 including an inlet 432 and an outlet 433, which define a flow path 421 for fluid, such as fluid that pools/accumulates on the flexible membrane to which the drain apparatus 420 is coupled, through the interior of the housing 422. Within the housing 422 is disk 431 configured to be held against the inlet 432 via a spring force provided by a spring 430. The disk 431 is configured to swing about a hinge 435 in a swing direction 436 when a threshold weight of fluid is detected on the drain apparatus 420. For example, when the threshold weight of fluid accumulates on and around the disk 431, the weight of the fluid can displace and/or push the disk 431 away from the inlet 432 (e.g., in the swing direction 436), allowing the fluid to drain through the housing 422 and discharge out the outlet 433. In some embodiments, such as shown in FIG. 4, the disk 431, spring 430, and hinge 435 are formed of a single elastic component.

In some embodiments, a channel structure 434, such as a hose or a trough, is configured to receive the fluid discharging from the outlet 433 of the housing 422. In some embodiments, the channel structure is coupled (e.g., via fastener threads, clamps, etc.) to a lower section 429 of the housing, to ensure a contained and/or enclosed flow path 421 from inlet 432 to outlet 433 and away from the drain apparatus 420.

In some embodiments, the drain apparatus 420 is configured to couple to the flexible membrane via a sealing nut 427 and a sealing washer 424. The sealing nut 427 is configured to couple to an upper section 428 (e.g., via fastener threads, clamps, etc.) of the housing 422 such that the sealing nut 427 provides a mechanical force on the sealing washer 424 that clamps the sealing washer 424 to the housing 422. In some embodiments, a portion of the flexible membrane is positioned in clamping location 423, which is between a sloped section 426 the sealing washer 424 and a beveled portion 425 of the housing 422. When the sealing nut 427 applies the mechanical force to the sealing washer 424, the portion of the flexible membrane is clamped in clamping location 423 between the sloped section 426 and the beveled portion 425.

FIG. 5A is a perspective view of a drain apparatus 540, configured in accordance with some embodiments of the disclosed technology. FIG. 5B is a partially-schematic cross-sectional view of the drain apparatus 540 of FIG. 5A. In some embodiments, drain apparatus 540 includes features and components generally similar/identical to features and components of any of the other embodiments of drain apparatuses discloses throughout this document (e.g., drain apparatus 210 of FIGS. 2A–2C, drain apparatus 320 of FIG. 3, and/or drain apparatus 420 of FIG. 4).

Referring to FIG. 5A, in the present embodiments, drain apparatus 540 is comprised of an outer ring 550 and an inner plug 560. As discussed further herein, the inner plug 560 is configured to couple to the outer ring 550, and the outer ring 550 is configured to couple to a flexible membrane 504 (shown in FIG. 5B). The drain apparatus 540 is configured to drain fluid through an opening of the flexible membrane 504, for example, when a threshold weight of fluid accumulates on the flexible membrane 504. In some embodiments, the drain apparatus 540 is configured to transmit light through the outer ring 550 and/or inner plug 560 (e.g., via a film 561, discussed further herein) when the outer ring 550 and inner plug 560 are coupled.

In some embodiments, the outer ring 550 includes an inner ring section 552 (i.e., a first ring section) and an outer ring section 554 (i.e., a second ring section). In some embodiments, the inner ring section 552 is configured to define an opening 551 of the outer ring 550, through which fluid can flow (e.g., when a threshold weight of fluid on the flexible membrane 504 and/or drain apparatus 540 is met or exceeded). In such embodiments, the opening 551 can be aligned with the opening of the flexible membrane 504 to allow fluid to flow through both the opening 551 and the opening of the flexible membrane 504. The opening 551 is further configured to receive the inner plug 560 such that fluid is at least substantially prevented from flowing through the opening 551 when the inner plug 560 is coupled to the outer ring 550. In some embodiments, the inner ring section 552 includes a sloped portion 553 (i.e., a first sloped portion) configured to mate with a corresponding sloped portion 555 (i.e., a second sloped portion) of the outer ring section 554.

In some embodiments, the outer ring 550 includes an outer coupling mechanism 556 configured to clamp the outer ring section 554 to the inner ring section 552 when the outer coupling mechanism 556 is coupled to the outer ring 550. For example, the outer coupling mechanism 556 can include an outer nut 558 and an outer washer 557 with an outer coupling surface 559 (e.g., fastener threads). When the outer coupling surface 559 is mated with a corresponding coupling surface of the inner ring section 552 and/or outer ring section 554 (e.g., corresponding fastener threads), the outer coupling mechanism 556 can drive inner ring section 552 and the outer ring section 554 together such that the first sloped portion 553 and second sloped portion 555 are clamped together. In some embodiments, the outer ring 550 is configured to couple to the flexible membrane 504 by clamping a portion of the flexible membrane 504 between the first and second sloped portions 553, 555 when the first and second sloped portions 553, 555 are clamped together via the outer coupling mechanism 556.

In some embodiments, the inner plug 560 includes an inner plug section 562 (i.e., a first plug section) and an outer plug section 564 (i.e., a second plug section). In some embodiments, the outer plug section 564 defines a perimeter of the inner plug 560. In some embodiments, the inner plug section 562 defines an opening configured to admit light through the drain apparatus 540 and, for example, into the interior of a greenhouse. In such embodiments, the inner plug section 562 includes a transparent and/or semitransparent film layer 561 stretched over the opening of the inner plug section 562. The film layer 561 is configured to prevent and/or substantially prevent fluid (e.g., rainwater) and particles from passing through the opening of the inner plug section 562 while allowing light to be transmitted through the opening. In some embodiments, the film layer 561 is comprised of one or more of the transparent and/or semitransparent materials described throughout this document. One advantage of this configuration is that the drain apparatus 540 can be relatively large and/or take up a relatively large surface area of the flexible membrane 504 and/or roof structure to which the drain apparatus 540 is coupled while still allowing sufficient light to reach the interior of the structure (including plants inside the structure).

In some embodiments, the inner plug section 562 includes a first beveled portion 563, and the outer plug section 564 includes a second beveled portion 565. The first and second beveled portions 563, 565 are configured to correspond and mate with each other when an inner coupling mechanism 566 is coupled to the inner plug 560. For example, as shown in FIG. 5B, the inner coupling mechanism 566 can include an inner nut 568 and inner washer 567 with an inner coupling surface 569 (e.g., fastener threads). When the inner coupling surface 569 is mated with a corresponding coupling surface of the inner plug 560 and/or outer plug section 564 (e.g., corresponding fastener threads), the inner coupling mechanism 566 can drive inner plug section 562 and outer plug section 564 together such that the first beveled portion 563 and the second beveled portion 565 are clamped together. In some embodiments, the inner plug 560 is configured to couple to the film layer 561 by clamping at least a portion of the film layer 561 between the first and second beveled portions 563, 565 when the first and second beveled portions 563, 565 are clamped together via the inner coupling mechanism 566.

In some embodiments, the outer ring 550 and the inner plug 560 are configured to detachably couple to each other. For example, when the inner plug 560 is positioned at least approximately within the opening 551 of the outer ring 550, the inner plug 560 can be clamped and/or fastened to the outer ring 550 to form a water-tight or near-water-tight barrier that at least substantially prevents fluid and particles from passing through the opening 551. When a threshold weight of fluid is accumulated on the flexible membrane 504 and/or drain apparatus 540, the inner plug 560 can decouple from the outer ring 550 to allow the accumulated fluid to drain through the opening 551. In some embodiments, the outer ring 550 and inner plug 560 are coupled together via one or more clamps, and the like. In some embodiments, the inner plug 560 and the outer ring 550 are coupled via one or more magnetic elements (e.g., magnets).

In some embodiments, the drain apparatus 540 is configured to transmit gas (e.g., air) from inside a structure, such as a greenhouse, to outside the structure. In such embodiments, the inner plug 560 can be configured to decouple from the outer ring 550 based on a threshold pressure of the structure, an area proximate the drain apparatus 540, and/or a differential pressure across the drain apparatus 540. For example, when a threshold differential pressure is met or exceeded across the drain apparatus 540 (e.g., as a result of aerodynamic forces of wind creating a low pressure condition on the exterior surface of the flexible membrane 504 and/or on the drain apparatus 540), the inner plug 560 can decouple and/or pop out from the outer ring 550 to allow air to pass through the opening 551, thus relieving pressure across the drain apparatus 540 and/or flexible membrane 504. This can mitigate and/or prevent flexible membrane 504 rupture or deformation when such pressure conditions are present.

In some embodiments, the outer ring 550 and inner plug 560 are coupled together by a friction force between the inner plug 560 and the outer ring 550. For example, the outer ring 550 and the inner plug 560 can be coupled via a friction force between the outer plug section 564 and the inner ring section 552. In such embodiments, the threshold weight of fluid can be based at least partially on the friction force between the outer ring 550 and the inner plug 560. Additionally or alternatively, the friction force can be based on the threshold weight of fluid. When the threshold weight of fluid meets and/or exceeds the friction force between the inner plug 560 and the outer ring 550, the inner plug 560 decouples from the outer ring 550 and fluid drains through the opening 551.

In some embodiments, the drain apparatus 540 is communicably coupled to a controller 542 configured to control one or more operations and/or parameters of the drain apparatus 540. For example, the controller 542 can be configured to detect, via one or more sensors, when a threshold weight of fluid has accumulated on the flexible membrane 504. In response to the threshold weight being met and/or exceeded, the controller 542 can control and/or direct decoupling of the inner plug 560 from the outer ring 550, such as the release of one or more clamps coupling the inner plug 560 to the outer ring 550.

In some embodiments, the controller 542 includes one or more hardware and software components for controlling operation of the drain apparatus 540. For example, the controller 542 can include one or more processors (e.g., central processing unit(s) (CPU(s)), graphics processing unit(s) (GPU(s)), holographic processing unit(s) (HPU(s)), etc.) and memory (e.g., volatile storage, non-volatile storage) for storing instructions to be executed by the one or more processors. The controller 542 can include or be in the form of one or more controllers, one or more controller circuits, or the like, or a combination thereof. Examples of controllers can include a microcontroller, a programmable logic controller (PLC), a digital signal controller (DSC), a motor controller, or the like, or a combination thereof. In some embodiments, the controller 542 can include a control circuit formed by a plurality of controllers.

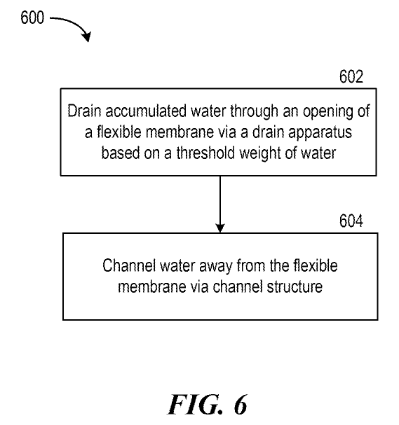

FIG. 6 is a flow diagram of a method 600, in accordance with some embodiments of the disclosed technology. In some embodiments, one or more steps of method 600 are performed using the systems 100 and/or 200 of FIGS. 1A and 1B, and/or 2A–2C, respectively and/or the drain apparatuses 210, 320, 420, and/or 540 of FIGS. 2A–5B, respectively.

At block 602, water that has accumulated and/or pooled on a flexible membrane and/or drain apparatus are drained through an opening of the flexible membrane via the drain apparatus. In some embodiments, draining the water is based on a threshold weight of water accumulating on the flexible membrane and/or drain apparatus. In some embodiments, the flexible membrane is coupled to and/or integrated with an exterior surface of a structure, such as a greenhouse. In some embodiments, the drain apparatus is coupled to the flexible membrane such that the drain apparatus covers (e.g., creates a water-tight or near-water-tight barrier over) the opening of the flexible membrane.

At block 604, the water that drains through the opening of the flexible membrane is channeled (e.g., via a channel structure such as an additional flexible membrane, trough, hose, and/or the like) away from the flexible membrane.

In some embodiments, method 600 can also include decoupling at least a portion of the drain apparatus from the opening based on meeting or exceeding the threshold weight of water on the flexible membrane and/or drain apparatus. For example, an inner plug of the drain apparatus can decouple from an outer ring of the drain apparatus based on meeting or exceeding the threshold weight of water.

In some embodiments, the method 600 can also include decoupling at least a portion of the drain apparatus from the opening based on meeting or exceeding a threshold pressure (e.g., differential pressure across the drain apparatus and/or flexible membrane. For example, an inner plug of the drain apparatus can decouple (e.g., pop out) from an outer ring of the drain apparatus based on a threshold differential pressure across the flexible membrane.

I/We claim:

1. A water relief system comprising:
a flexible membrane coupled to an exterior surface of a structure, the flexible membrane including an opening; and
a drain apparatus coupled to the flexible membrane such that the drain apparatus covers the opening, wherein the drain apparatus is configured to drain water through the opening based on a threshold weight of water on the flexible membrane.

2. The system of claim 1, further comprising a channel structure configured to receive water passing through the opening and to transport the water away from the flexible membrane.

3. The system of claim 1, wherein the drain apparatus is bonded to the flexible membrane via an adhesive, and wherein the adhesive is one or more of: glue, tape, and/or a clamp, wherein the adhesive bond to the flexible membrane is released based on the threshold weight of water on the flexible membrane.

4. The system of claim 1, wherein the drain apparatus is coupled to the flexible membrane via at least one washer and at least one nut.

5. The system of claim 4, wherein the drain apparatus includes a housing, and wherein the at least one washer includes a raised portion configured to mate with a recess in the housing.

6. The system of claim 1, wherein the drain apparatus includes a relief valve configured to provide a flow path for water accumulating on the flexible membrane through a housing of the relief valve.

7. The system of claim 6, wherein the relief valve includes:
a displaceable disk;
a hinge; and
a spring;
wherein the displaceable disk is configured to rotate about the hinge, and the spring is configured to hold the displaceable disk in a shut position until the threshold weight of water is met or exceeded.

8. The system of claim 2, wherein the flexible membrane is a first flexible membrane, and wherein the channel structure is a second flexible membrane, wherein the second flexible membrane is configured to transport water away from the first flexible membrane.

9. The system of claim 1, wherein the drain apparatus is further configured to transmit gas from inside the structure to outside the structure via the opening based on a pressure of an interior area of the structure.

10. The system of claim 1, wherein the drain apparatus includes:
a housing configured to provide a flow path for water on the flexible membrane through the opening when the threshold weight of water is met or exceeded, wherein the housing includes a beveled portion; and
a sloped outer ring configured to mate with the beveled portion;
wherein at a portion of the flexible membrane is configured to be clamped between the sloped outer ring and the beveled portion of the housing when the drain apparatus is coupled to the flexible membrane.

11. The system of claim 1, wherein the drain apparatus is further configured to transmit light through the drain apparatus and the opening of the flexible membrane while the drain apparatus is coupled to the flexible membrane.

12. The system of claim 1, wherein the threshold weight is based at least in part on one or more of: a geometry of the flexible membrane, a geometry of the opening, a tensile strength of the flexible membrane, a material of the flexible membrane, a number of connection points between the flexible membrane and the exterior surface of the structure, a position of one or more connection points between the flexible membrane and the exterior surface of the structure, a position of the drain apparatus on the flexible membrane, a type of drain apparatus, a type of adhesive, a position of the opening, and/or a density of water.

13. A drain apparatus comprising:
an outer ring including:
a first ring section including a first sloped portion, wherein the first ring section defines an opening through the outer ring;
a second ring section including a second sloped portion, wherein the second ring section forms a perimeter of the outer ring; and
an outer coupling mechanism configured to clamp the first ring section to the second ring section such that the first and second sloped portions mate; and
an inner plug configured to be positioned in the opening of the outer ring and to be coupled to the outer ring, the inner plug including:
a first plug section including a first beveled portion;
a second plug section including a second beveled portion, wherein the second plug section forms a perimeter of the inner plug;
a film configured to transmit light through the drain apparatus; and
an inner coupling mechanism configured to clamp the first plug section to the second plug section such that the film is clamped between the first and second beveled portions;
wherein the inner plug is configured to decouple from the outer ring when a threshold weight of fluid is positioned on top of the inner plug.

14. The apparatus of claim 13, wherein the inner plug is configured to be coupled to the outer ring via a friction force between the first sloped portion of the first ring section and the second beveled portion of the second plug section.

15. The apparatus of claim 13, wherein the inner plug is configured to couple to the outer ring via one or more of: magnetic elements, snaps, protrusions, bumps, recesses, grooves, fasteners, and/or clamps.

16. The apparatus of claim 13, wherein the outer coupling mechanism includes at least one washer and at least one nut, and wherein the washer and the nut are configured to clamp the first ring section to the second ring section.

17. The apparatus of claim 13, wherein the inner coupling mechanism includes at least one washer and at least one nut, and wherein the washer and the nut are configured to clamp the first plug section to the second plug section.

18. A method comprising:
draining accumulated water through an opening of a flexible membrane of an exterior surface of a structure via a drain apparatus, wherein the drain apparatus is coupled to the flexible membrane such that the drain apparatus covers the opening, and wherein the water is drained based on a threshold weight of water accumulated on the flexible membrane; and
channeling the accumulated water away from the flexible membrane via one or more channel structures.

19. The method of claim 18 further comprising decoupling at least a portion of the drain apparatus from the opening based on meeting or exceeding the threshold weight of water on the flexible membrane.

20. The method of claim 19, wherein decoupling at least a portion of the drain apparatus includes decoupling an inner plug from an outer ring based on the threshold weight of water meeting or exceeding a friction force between the inner plug and the outer ring.
